(19) United States
(12) Patent Application Publication
(10) Pub. No.: US 2025/0214809 A1
(43) Pub. Date: Jul. 3, 2025

(54) INTERNALLY FLANGED BODY LIFTING TOOL

(71) Applicant: F.LLI RIGHINI S.R.L., RAVENNA (IT)

(72) Inventors: Franco Argelli, Ravenna (IT); Renzo Righini, Ravenna (IT)

(73) Assignee: F.LLI RIGHINI S.R.L., RAVENNA (IT)

(21) Appl. No.: 18/853,513

(22) PCT Filed: Apr. 7, 2022
(86) PCT No.: PCT/IB2022/053277

§ 371 Date: Oct. 2, 2024

(51) Int. Cl. B66C 1/56; B66C 1/66

(52) U.S. Cl. CPC B66C 1/56; B66C 1/66

(57) ABSTRACT

The present invention consists of a lifting tool (1) for internally flanged bodies comprising: a body (8) consisting of a solid supporting structure; means (19) to ensure the rotation of a lever (10); means (10) for moving rods (9): these means consist of a lever (10) placed in rotation on the pin (19) by at least one hydraulic cylinder (14), which is connected to said lever (10) by means of a hinge (13) and to said body (8) by means of a hinge (11); means (14) for moving the lever (10); means (9) for pushing petals (5) radially outwards: these means consist of a rod (9) for each petal (5): said rods (9) are connected to the lever (10) by means of hinges (12) and to the petals (5) by means of hinges (20); means (5) to ensure the centering of the body (8) with respect to the pipe (2); to also ensure the lifting of said pipe (2) by engaging the flange (3), welded to the pipe (2): such means consist of at least three petals (5), constrained in movement by at least one sliding block (16) for each petal (5): each such sliding block (16) being slidable in a guiding slot (15) machined into the body of the petal (5); means (16) to ensure the radial movement of the petal (5) with respect to the geometric axis of the body (8); these means consist of at least one sliding block (16) for each petal (5): each such sliding block (16) being slidable relative to the petal (5) in a guiding slot (15) machined into the body of the petal (5) itself; means (6) to ensure that during the lifting of the petals (5) the petals (5) do not leave their seat; these means consist of supports (6) able to counteract the upward force that is generated on the back of the petal (5) during the lifting operation.

The present patent for invention concerns the technical field related to lifting tools, in particular it is used to lift bodies with internal flanges. As is known, at present in the field of lifting tools there are different types of terminals for lifting objects provided with internal flanges, based on bolted connections, or on openable elements that fit under the flange itself.

The bolted connections require long times and lack in safety, while those so far on the market with openable elements have the defect of not ensuring the perfect centering; furthermore they rest under the flange in a not optimal position as regards the stresses on the flange itself, risking to damage it. Furthermore, the active rest angle is often limited, again to the detriment of the stresses on the body to be lifted.

The object of the present invention is to eliminate the aforesaid and other inconveniences, by providing a simple and economical system to form a lifting tool of low cost, durable over time, which allows at the same time to lift the flanged body in a centered and balanced manner and stressing it to the minimum possible thus avoiding damage. All of this according to the characteristics written in the independent claims. Other characteristics of the invention are subject of the dependent claims.

The advantages arising from the present invention consist essentially of the following:
that the lifting tool allows to perfectly center the body to be lifted, as it is provided with supporting means that engage synchronously under the flange, by moving radially until the inner diameter of the pipe is reached, with a force sufficient to move the tool (1) itself until the perfect centering is achieved;
that in this manner the flange is lifted by putting pressure on a surface portion in a position such as to ensure that the stress is minimized; that the angle of support is very large, again in order to minimize the stress on the flange;
that a sufficiently deformable material is interposed between the flange and the lifting petals to ensure the maximum possible uniformity of the contact pressure between the lifting tool and the flange;
that all this is obtained in a simple and economic manner.

The originality and functionality of the invention will be better understood, by every expert in the art, from the description that follows, with the aid of the annexed drawings that show the non-exhaustive or non-limiting implementation solutions, in which:

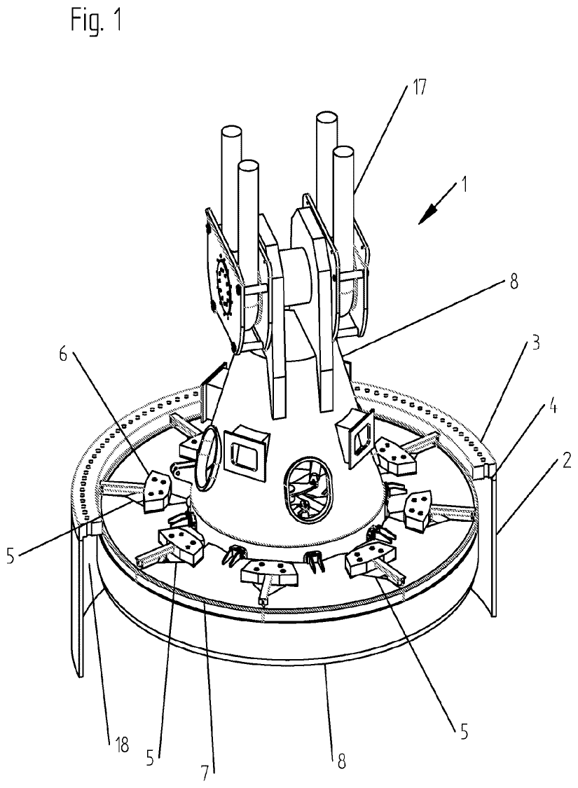

FIG. 1 shows the lifting tool (1) in a perspective view, with parts not shown for simplicity, of a first preferred embodiment of the lifting tool (1): this is composed of a structure mostly made of steel, preferably lifted by means of cables (17).

The following can be seen; the body (8), the petals (5) shown in a closed configuration, the supports (6) that bear the upward vertical thrust of the petals during the lifting, the pipe (2) structurally connected to the flange (3) by means of welding or mechanical connection, the point (4) of greater stress on the flange (3) during lifting, the inner surface (18) of the pipe (2), the sector (7) made of deformable material to make the contact pressure between the tool and the lower surface of the flange as uniform as possible.

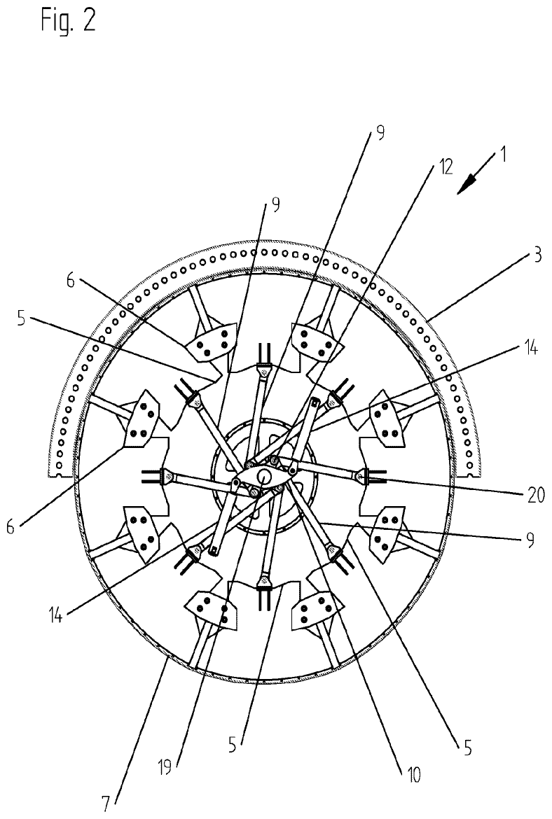

FIG. 2 again shows the lifting tool (1) in plan view, with parts not shown for simplicity.

The following can be seen; the petals (5) shown in a closed configuration, the supports (6) that bear the upward vertical thrust of the petals during lifting, the flange (3), the sector (7) made of deformable material, the pin (19) around which the lever (10) placed in rotation by the jacks (14), in order to move the rods (9); these are hinged to the lever in the pins (12) and to the petals (5) in the pins (20): the displacement of the rods (9) causes the radial movement of the petals (5) all the way up to below the flange (3), a movement that is synchronized since the rods (9) have the same length and are all hinged to the same lever (10) on the same radius of rotation.

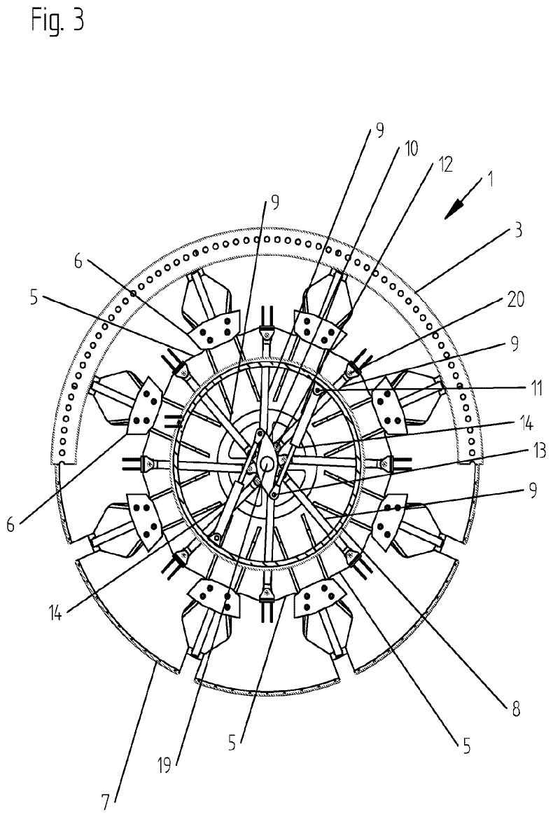

FIG. 3 shows the lifting tool (1) again in plan view, with parts not shown for simplicity.

The following can be seen; the petals (5) this time shown in an open configuration, the supports (6) that bear the upward vertical thrust of the petals during lifting, the flange (3), the sector (7) made of deformable material, the pin (19) around which the lever (10) rotates, placed in rotation by the jacks (14), in order to move the rods (9); these are hinged to the lever in the pins (12) and to the petals (5) in the pins (20); the displacement of the rods (9) causes the radial movement of the petals (5) up to below the flange (3), a movement that is synchronized since the rods (9) have the same length and are all hinged to the same lever (10) on the same radius of rotation. Also the pins (13) attaching the jacks (14) to the lever (10) and the pins (11) attaching the jacks (14) to the body (8) can be seen.

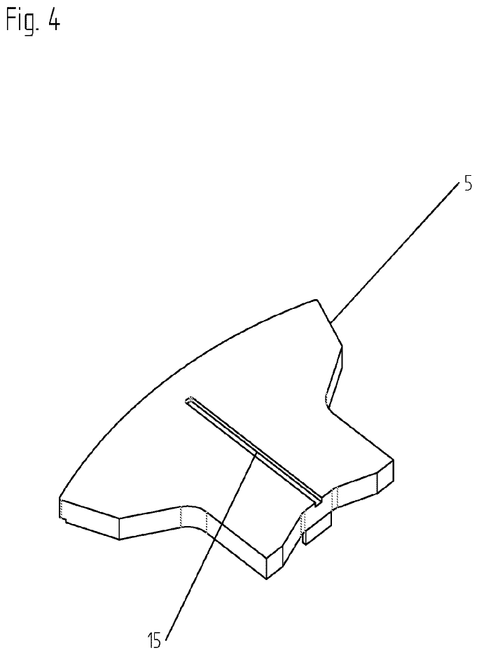

FIG. 4 shows in a perspective view the petal (5), which is provided with a guiding slot (15) at the bottom for the radial sliding of the petal (5) itself.

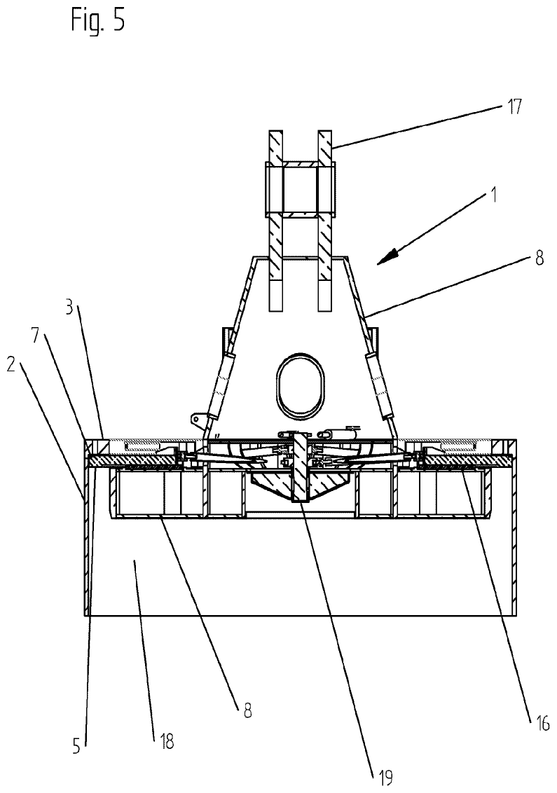

FIG. 5 shows the lifting tool (1) in a sectional view. The body (8), the pipe (2) connected to the flange (3), the inner surface (18) of the pipe (2), the sector (7) made of deformable material, the petals (5), the rotation pin (19) of the lever (10), the sliding block (16) for guiding the petal (5), the lifting cables (17) of the lifting tool (1) can be seen.

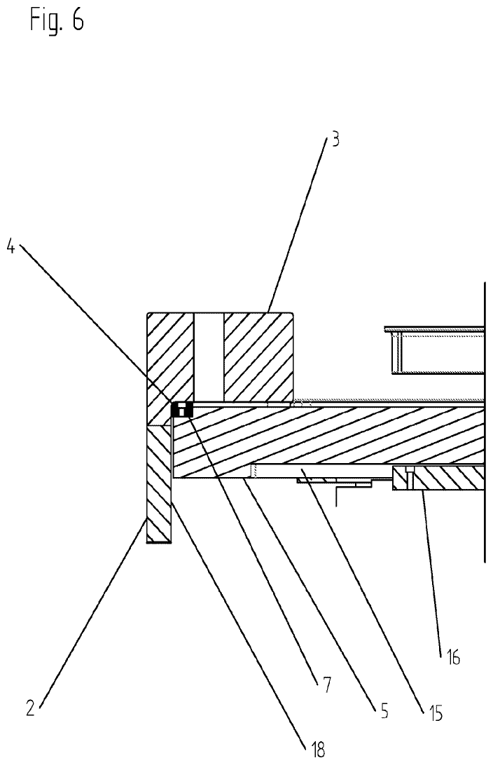

FIG. 6 shows in a sectional view the pipe (2) connected to the flange (3), the internal surface (18) of the pipe (2), the sector (7) made of deformable material, the petals (5), the sliding block (16) for guiding the petal (5), sliding block that is engaged in the slot (15). The following can also be seen; the point (4) of greater stress on the flange (3) at the moment of lifting. It should be noted that in this configuration, which is the lifting configuration, the sector (7) made of deformable material is pushed up to the inner cylindrical surface (18) of the pipe (2), so as to minimize the bending moment and therefore the stress acting on point (4) of the flange (3): for the same purpose, the shape of the sector (7) made of deformable material is such as to adapt to the shape of the connecting radius between the flange and the inner cylindrical surface (18) of the pipe (2), so as to minimize the bending moment and therefore the stress acting on the point (4) of the flange (3) with the same area of the contact surface.

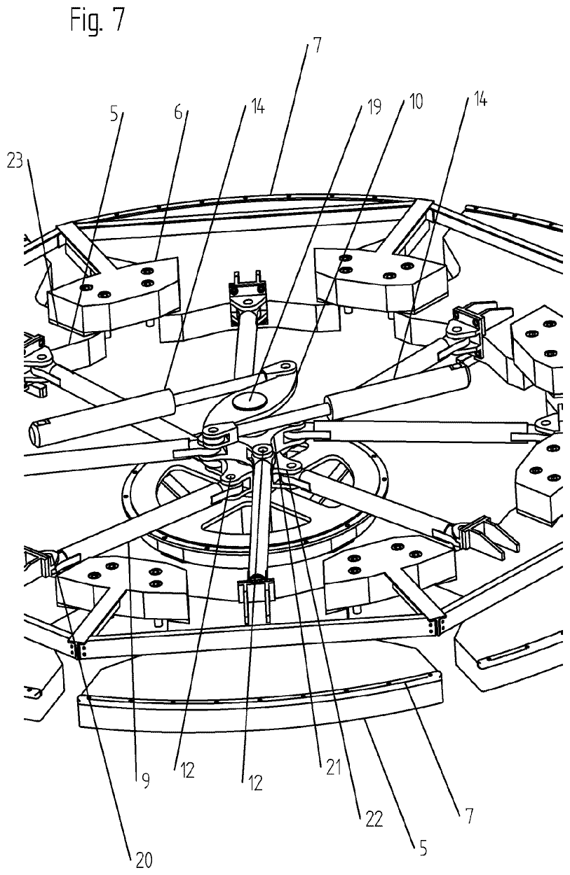

FIG. 7 shows a cut-out of the lifting tool (1) in a perspective view, with parts not shown for simplicity.

The following can be seen; the petals (5) shown in an open configuration, the supports (6) that bear the vertical upward thrust during lifting, the wear elements (23) interposed between the petals (5) and the supports (6), the sector (7) made of deformable material; the following can also be seen; the pin (19) around which the lever (10) rotates, placed in rotation by the jacks (14), in order to move the rods (9); these are hinged to the lever in the pins (12) and to the petals (5) in the pins (20); then the elements (21) and (22), integral in the movement with the lever (10), which carry the hinges (12) for attaching the rods (9), elements (21) and (22) that for reasons of space, in this form of construction, are placed on two different planes, can be seen.

However, it should be underlined that the scope of the present invention cannot be limited exclusively to the diagrams attached hereto. The purpose of these diagrams is solely to clarify and illustrate the operation of the present invention in a quick and comprehensible manner: therefore, they do not claim to show construction details which, in practice, may be updated, implemented or modified while remaining completely in the spirit of the invention itself. Also the terms “above”, “below”, “upper”, “lower”, “parallel”, “perpendicular” and in general all the terms indicating positioning and direction are mentioned only as a function of the figures and of the description herein, and do not consist t of any constraint on the final construction of the invention, nor any limitation.

The lifting tool (1), in a first preferred embodiment, is formed of a body (8) adapted to be lifted by cables (17). This body (8) carries, axially centered, a pin (19) around which a lever (10) rotates, placed in rotation by at least one hydraulic jack (14), bound to the lever (10) in a hinge (13) and to the body (8) in a hinge (11). The rods (9), all of equal length between them, are also constrained to this lever (10), by means of hinges (12): for reasons of space, the hinges (12) can be placed on two planes parallel to each other instead of lying on the same plane. When the lever (10) rotates, the rods (9) move according to a rod-crank type movement, causing the synchronous radial displacement of the petals (5), which are connected to the rods (9) by means of hinges (20). The petals (5) are forced to move radially as they are constrained by a guide (16) that engages in a slot (15) machined in the petal (5) itself. The movement of the petals (5) is synchronized by geometry, since the rods (9) have the same length, are all hinged to the same lever (10) on the same radius of rotation, and the hinges (12) lie either in the same plane, or in two planes symmetrical with respect to a median plane coincident with the plane of the hinges (20). When the petals (5), with the deformable sectors (7) interposed between, touch the inner wall (18) of the pipe (2), the lifting tool (1) moves until it is perfectly centered on the same pipe (2), since the petals (5) move radially to the same extent, and the thrust of the hydraulic jacks (14) is sufficient for this purpose. At this point the lifting can begin, with the deformable sectors (7) which engage on the lower face of the flange (3) close to the point (4) of maximum stress, in order to minimize the same stress. The deformable sectors (7), partially yielding under the contact pressure due to the lifting, ensure that sufficient uniformity of the same contact pressure is achieved, in order to generate as uniform stresses as possible on the connecting radius of the flange along the contact arc and therefore not to damage the flange: the aforesaid deformable sectors (7) have a surface such as to bear the weight of the lifting, but are at the same time as narrow as possible in order to act close to the point (4) of maximum stress. The upward thrust resulting from the lifting manoeuvre and acting on the petals (5) is borne by the supports (6), with the interposed wear elements (23) mounted between the aforesaid supports (6) and the petals (5).

1) A lifting tool (1) for internally flanged bodies characterized in that it comprises:
a body (8) consisting of a solid supporting structure, preferably steel;
means (19) to ensure the rotation of a lever (10): these means consist of a pin (19), which is substantially coaxial with the body (8) of the structure and supported by it;
means (10) for moving rods (9): these means consist of a lever (10) placed in rotation on the pin (19) by at least one hydraulic cylinder (14), which is connected to said lever (10) by means of a hinge (13) and to said body (8) by means of a hinge (11);
means (14) for moving the lever (10): these means consist of at least one hydraulic cylinder (14), which is connected to said lever (10) by means of a hinge (13) and to said body (8) by means of a hinge (11);
means (9) for pushing petals (5) radially outwards: these means consist of a rod (9) for each petal (5): said rods (9) are connected to the lever (10) by means of hinges (12) and to the petals (5) by means of hinges (20);
means (5) to ensure the centering of the body (8) with respect to the pipe (2); to also ensure the lifting of said pipe (2) by engaging (abutting against?) the flange (3), welded to the pipe (2): such means consist of at least three petals (5), constrained in movement by at least one sliding block (16) for each petal (5): each such sliding block (16) being slidable in a guiding slot (15) machined into the body of the petal (5);
means (16) to ensure the radial movement of the petal (5) with respect to the geometric axis of the body (8); these means consist of at least one sliding block (16) for each petal (5): each such sliding block (16) being slidable relative to the petal (5) in a guiding slot (15) machined into the body of the petal (5) itself;
means (6) to ensure that during the lifting of the petals (5) the petals (5) do not leave their seat; these means consist of supports (6) able to counteract the upward force that is generated on the back of the petal (5) during the lifting operation.

2) The lifting tool (1) for internally flanged bodies according to claim 1, characterized in that a deformable element (7), called a sector, is present between each petal (5) and the flange (3), in order to ensure a uniform contact pressure between each petal (5) and the flange (3).

3) The lifting tool (1) for internally flanged bodies according to claim 1, characterized in that the elements (21) and (22), which contain the hinges (12) connecting the lever (10) and the rods (9) and which are integral with said lever (10), are arranged on two planes: these planes are symmetrical with respect to a median plane, on which lie the hinges (20) connecting the rods (9) and the petals (5).
